(19) United States
(12) Patent Application Publication
(10) Pub. No.: US 2026/0193848 A1
(43) Pub. Date: Jul. 9, 2026

(54) SEALING MOLDING APPARATUS SECTIONS

(71) Applicant: Peridot Print LLC, Palo Alto, CA (US)

(72) Inventors: Javier LEDESMA FERNANDEZ, Sant Cugat del Valles (ES); Lluis PARE BARNIOL, Sant Cugat del Valles (ES); Roger FADURDO ORELLANA

(21) Appl. No.: 19/123,933

(22) PCT Filed: Oct. 31, 2022
(86) PCT No.: PCT/US2022/048461

§ 371 Date: Apr. 24, 2025

(51) Int. Cl. D21J 3/00; B33Y 80/00

(52) U.S. Cl. CPC D21J 3/00; B33Y 80/00

(57) ABSTRACT

In an example, a first molding apparatus section comprises a body portion and a joining portion. In some examples the body portion is for forming at least part of a pulp molded object. The joining portion may be to mate with at least a second molding apparatus section to form a pulp molding apparatus component, the joining portion comprising a plurality of protruding features which interact with pulp molding fibers to form a seal between the first and second molding apparatus sections.

### BACKGROUND

Objects may be formed from a pulp of material in a pulp molding process. The pulp may comprise a mixture of solid material (for example formed from recycled cardboard and/or paper) and a liquid such as water. A pulp molding die, which may include a screen and a main body, also referred to as a form, may be immersed in a pulp. The liquid may be drawn through the pulp molding die such that solid material in the pulp accumulates on the screen to form an object in an intended shape. When the object has been formed on the screen, it may then be transferred to a transfer member. The screen, form and transfer member may collectively be referred to as a pulp molding toolset and may comprise multiple molding apparatus sections or parts which are assembled to form each pulp molding apparatus component.

### BRIEF DESCRIPTION OF DRAWINGS

Non-limiting examples will now be described with reference to the accompanying drawings, in which:

FIG. 1 is a cross section of an example of a pulp molding apparatus section;

FIGS. 2A to 2J are cross sections of example pulp molding apparatus sections;

FIGS. 3A to 3D are examples of a pulp molding apparatus component;

FIG. 4 is a flowchart of an example of a method for obtaining and modifying a model representing a portion of a molding apparatus; and

FIG. 5 is a flowchart of an example of a method for forming a pulp molding toolset component and forming a molded pulp object using the pulp molding toolset component.

### DETAILED DESCRIPTION

A molded pulp object may be an object formed using a pulp molding process. Such objects have many uses, for example in packaging of produce such as eggs and fruit, or electrical appliances or the like. A pulp molding die may comprise a screen and a form which supports the screen. Pulp molding processes comprise covering the screen of a pulp molding die with a slurry, or pulp, comprising a liquid component, such as water, and a solid, fibrous material. The screen of the pulp molding die may comprise a surface having a shape which corresponds to the shape of a surface of an object to be formed using the die. The die may be submersed in a bath of the slurry to cover the screen of the die.

The screen of the pulp molding die may comprise pores (i.e. small holes, or porous zones) in the surface which allow the liquid component of the slurry to pass through, but are sufficiently small that the solid, fibrous material accumulates on the surface of the screen to form the object. In some examples pressure may be reduced behind the die to suck the liquid through the pores in the screen and to suck the fibrous material towards the surface of the screen. In some examples, a reduced pressure may be insufficient to dry the fibrous material, and therefore additional drying may be achieved by a further drying process, for example by heating the material to cause evaporation of the liquid or by application of pressure. The drying may take place in an oven or between heated metal dies.

Prior to drying, the object may be transferred from the pulp molding die to a transfer apparatus. This transfer may comprise supplying air through the screen of the pulp molding die to blow the object from the pulp molding die to the transfer apparatus.

Components may be used together to provide a pulp molding apparatus. In some examples, alignment features are provided, for example a hole may be provided in each component through which a pin, rod or bolt may be inserted. In some examples multiple alignment features (e.g. a plurality of holes to receive pins or bolts) may be provided in the components. In some examples alignment features such as corresponding ridges or channels may be provided. In some examples adhesives may be used to join components.

In some examples a pulp molding apparatus component may comprise multiple sections which are to be assembled to form the pulp molding apparatus component. For example, a pulp molding apparatus component such as the screen, form or transfer member may be formed by assembling multiple molding apparatus sections. Similarly pulp molding apparatus components may be assembled to form a portion of the pulp molding toolset, for example the screen and the form may be assembled to form a pulp molding die. Assembling components from smaller sections may be a practical way to provide pulp molding transfer components which are sufficiently large to form large objects or to form several objects within a single pulp molding operation.

For example, each section may be created using a manufacturing process which is unable to create objects above certain dimensions. For example, a particular manufacturing apparatus may be able to generate objects up to a certain size. For example, a particular example additive manufacturing system may generate an object of up to 380 mm by 284 mm, by 380 mm in height. However, a pulp molded object may be intended to exceed these dimensions. Therefore, sections can be generated using the example additive manufacturing apparatus and assembled prior to use to provide a larger component. In examples where the pulp molding components are formed using additive manufacturing, forming pulp molding components from multiple sections may also reduce the cost of producing the pulp molding components because it may allow a higher packing density in the additive manufacturing apparatus.

Forming pulp molding components from multiple sections may also simplify storage and shipping of the components. Furthermore, if a section is to be replaced or removed for maintenance, this may be possible without replacing or removing the entire component.

Forming objects using pulp molding may utilise pressure differences or pressure gradients through the pulp molding apparatus components. When component(s) are formed from multiple sections, gaps may exist between the sections which can result in leaks. Leaks may in turn result in issues such as defects in the formed object or problems when transferring the object from the die to the transfer member. Leaks may also affect the removal of liquid from the formed object (referred to as ‘dewatering’) and may cause fibers to become trapped in the pulp molding apparatus components (referred to as ‘fiber retention’). Therefore, leaks may adversely affect the performance and efficiency of a pulp molding process. To reduce leaks in pulp molding apparatus, gaskets (e.g. rubber or silicone seals), foams and adhesives/glues have been used, however these may increase complexity of assembly, increase cost due to additional parts and assembly time and make disassembly more difficult. Furthermore, additives such as adhesives/glues may contaminate objects formed in a pulp molding process.

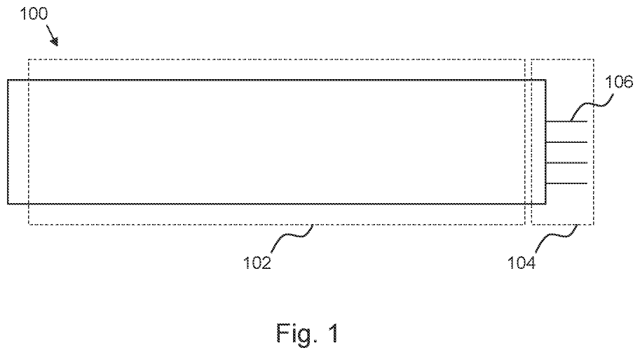

FIG. 1 shows an example of a first molding apparatus section 100, which may be used for forming objects using a pulp molding process. In this example the first molding apparatus section 100 comprises a body portion 102 and a joining portion 104.

In this example the body portion 102 is for forming at least part of a pulp molded object. The first molding apparatus section 100 may be a screen, a form or a transfer member, or a part thereof. For example, a screen, a form or a transfer member may be assembled from several sections, such as the first molding apparatus section 100.

A pulp molding die may comprise a screen which has a surface which may comprise a plurality of holes, pores or channels (e.g. recesses along a surface) through which a fluid may flow. In some examples the surface of the screen may comprise a mesh. The screen may be separable from the main body of the die, referred to herein as a form. The form may comprise any element which provides structural support for the screen which helps it to maintain its shape while forming an object. The form may also comprise holes or channels through which fluids may flow to and from the screen. In some examples the transfer member and/or the die may be formed from a metallic material or from a plastic material. In some examples they may be manufactured using machining techniques, such as CNC (Computer Numerical Control) milling or additive manufacturing as described above. The screen may be a woven mesh formed from a plurality of fine metal wires. The screen may comprise openings which have dimensions of around 0.1 mm to around 1.0 mm, for example around 0.1 mm to around 0.6 mm, for example 0.4 mm or 0.5 mm.

When the first molding apparatus section 100 is a screen (or a part of a screen), an object to be formed may be formed by accumulation of pulp molding fibers on the body portion 102. In such examples the body portion may be for forming at least part of the pulp molded object by providing a surface comprising pores, wherein, during a pulp molding operation, pulp molding fibers may accumulate on the surface.

When the first molding apparatus section 100 is a form (or a part of a form), an object to be formed may be formed by accumulation of pulp molding fibers on the screen which is supported by the body portion 102 of the form. Furthermore, the form may provide channels or openings through which fluid may flow during a pulp molding operation. In such examples the body portion 102 may be for forming at least part of the pulp molded object by providing a support to a screen on which pulp fibers accumulate and by providing a fluid pathway during a pulp molding operation.

When the first molding apparatus section 100 is a transfer member, pulp molding fibers may accumulate on a screen and subsequently be transferred to the transfer member, for example by supplying a fluid (e.g. a gas such as air) through the screen and/or form to blow the accumulated pulp molding fibers from the screen to the transfer member. In such examples the body portion 102 may be for forming at least part of the pulp molded object by receiving the accumulated pulp molding fibers from a screen. The accumulated pulp molding fibers may for example be dried while on the transfer member or transferred to a drying apparatus.

In this example, the joining portion 104 is to mate with at least a second molding apparatus section to form a pulp molding apparatus component. To form a pulp molding apparatus component, more than one molding apparatus section may be assembled. The joining portion 104 may be provided to form a joint with an adjacent molding apparatus section. The joining portion 104 may be an edge portion, that is, it may be provided along an edge of the first molding apparatus section 100 as shown in FIG. 1. However, in other examples the joining portion 104 may be provided in different locations, for example on an upper or lower surface of the first molding apparatus section 100. In this example, one joining portion 104 is illustrated, however in some examples a molding apparatus section 100 may comprise a plurality of joining portions, for example to allow the molding apparatus section 100 to mate with more than one other molding apparatus section. In an example, a molding apparatus section 100 may comprise a top face for forming a pulp molded object and a cross section of the molding apparatus section 100 substantially parallel to the top face may be rectangular. In such examples the molding apparatus section 100 may comprise up to four joining portions 104 arranged around the periphery of the molding apparatus section 100 (i.e. one on each side).

When the joining portion 104 mates with a second molding apparatus section, it may interact, e.g. cooperate, mesh, interlock or otherwise interact, to join with the second molding apparatus section as is described in greater detail below. For example, the second molding apparatus section may comprise a corresponding joining portion and each of the joining portions may comprise corresponding features to mate with each other.

In this example, the joining portion 104 comprises a plurality of protruding features 106. When the first molding apparatus section 100 is assembled to form a pulp molding apparatus component, the protruding features interact with pulp molding fibers to form a seal between the first molding apparatus section 100 and the second molding apparatus section. For example, the protruding features 106 may provide openings for a fluid to flow through. The openings may be sufficiently large to allow fluids to flow through, but small enough to impede passage of fibers, thereby causing the fibers to accumulate.

When the first molding apparatus section 100 and second molding apparatus section are initially assembled, there may be small gaps between the protruding features 106 and a surface of the second molding apparatus section. The surface of the second molding apparatus section may comprise corresponding features to interact, mesh or interlock with the protruding features 106 of the first molding apparatus section 100. However, in other examples the surface of the second molding apparatus section may not comprise any particular features and the protruding features 106 of the first molding apparatus section 100 may butt against the surface of the second molding apparatus section.

The gaps formed between the protruding features 106 and a surface of the second molding apparatus section may be openings which allow fluids to flow through (e.g. the liquid component of a pulp moulding slurry) but which are sufficiently small to block pulp molding fibers, thereby trapping the pulp molding fibers. In some examples the gaps may be larger than the fibers, but sufficiently small to slow the flow of slurry through the gaps such that the liquid and solid components of the slurry separate, causing accumulation of fibers at or around the protruding features 106. For example, some fibers may pass through the gaps and consolidate further within the molding apparatus component, rather than merely forming the pulp fiber seal on an exterior of the molding apparatus component. In some examples, a form or transfer member may be placed on a plate (e.g. a metallic plate) and fibers which pass through gaps may accumulate at an interface between the form or transfer member and the corresponding plate to form a seal therebetween.

In some examples, during a pulp molding operation, fluids may be drawn through the pulp molding apparatus component to form a pulp molded object. Due to dimensional tolerances or variations during manufacture, adjacent molding apparatus sections may have small spaces therebetween when assembled. Such spaces could allow fluid to leak through them during pulp molding operations as described above. However, in examples herein, as pulp molded fibers accumulate on the protruding features 106, the trapped fibers may form a seal to reduce the amount of fluid which leaks between molding apparatus sections thereby improving the quality of pulp molded objects and reducing issues associated with leaks. Therefore, by providing such protruding features, a space or gap between sections may be ‘self-sealing’, and such a seal may be formed in use of the pulp molding apparatus, in some examples in a priming operation as described below.

The first molding apparatus section 100 may be formed from a material such as a polymer, for example polyamide (e.g. PA11 or PA12) or polypropylene or an elastomer such as thermoplastic polyurethane (TPU) or thermoplastic amide (TPA). Such materials may be hydrophilic which causes pulp fibers to adhere to the material, for example due to hydrogen bonding. Such attachment is greater in rough or uneven areas. Therefore, providing protruding features which increase the surface area may encourage accumulation of pulp fibers to form the seal. In other examples the first molding apparatus section 100 may be formed from another material such as a metal.

The protruding features may be provided at any interface between sections and/or components of a pulp molding apparatus. For example, the screen, form or transfer member may comprise multiple sections and the protruding features may be provided between these sections. However, they may also be provided at interfaces between different components, for example at an interface between the screen and form, between the form and plate or between the transfer member and plate, wherein the plate is a component of the pulp molding apparatus.

A seal of pulp molding fibers may form relatively quickly during a pulp molding operation. However, in some examples a priming run or runs may be performed to accumulate sufficient material to form an effective seal. When beginning a run of pulp molding operations, a test run or runs may be performed, for example to test the installation of components (e.g. alignment of the form, screen and/or transfer member) and/or to allow calibration of process parameters (e.g. pressure, flow rates, temperature, consistency of the pulp). In such examples the seal of pulp molded fibers may be formed during the test run(s) and therefore the seal may be formed without additional priming runs. In some examples, when the seal of pulp molding fibers is formed, it may remain in place for multiple pulp molding operations. However, in some examples, the seal may be removed and reformed to prevent the seal from growing too large.

In this example, the joining portion 104 comprises a substantially flat face on which the protruding features 106 are provided, however in other examples the protruding features 106 may extend from a relatively complex surface. For example, the surface may be a curved (e.g. concave or convex surface) or may comprise compound curves. In other examples the surface may comprise a plurality of substantially flat faces or angular features. The use of protruding features which interact with pulp fibers to form a seal may allow a more complex geometry to be formed at the mating joining portions 104 of the first molding apparatus section 100 compared with other methods of providing a seal. For example, if a rubber or silicone gasket was used to provide a seal, it may not be possible to provide such complex geometries, in particular wide radius curves without discontinuities may be possible.

In some examples the body portion 102 and the joining portion 104, comprising the protruding features 106, are integrally formed using additive manufacturing. In other words, the body portion 102 and the joining portion 104 including the protruding features 106 may be formed from the same material during a single additive manufacturing operation such that the body portion 102 and the joining portion 104 including the protruding features 106 are a single integrally formed body. Additive manufacturing may generate a three-dimensional object through the solidification of a build material. The build material may be powder-based, and the properties of generated objects may depend on the type of build material and the type of solidification mechanism used. In a number of examples of such techniques build material is supplied in a layer-wise manner and the solidification method includes heating the layers of build material to cause melting in selected regions. In other techniques, chemical solidification methods may be used.

Using additive manufacturing to form the die (i.e. screen and/or form) or the transfer apparatus may allow them to be formed in shapes that would not be possible using other manufacturing processes. Furthermore, some aspects of the die, screen or transfer apparatus may be improved by use of additive manufacturing, for example channels or holes may be formed in shapes which improve fluid flow through the apparatus. Additive manufacturing may also reduce the cost of manufacturing the die and the transfer apparatus. For example, a pulp molding die and/or transfer apparatus may be made for specific customers (e.g. with unique branding). Additive manufacturing may also simplify incorporation of features of digital design workflows and digital analysis because it is a digital process, for example including use of computational fluid dynamics in designing the die, screen or transfer apparatus.

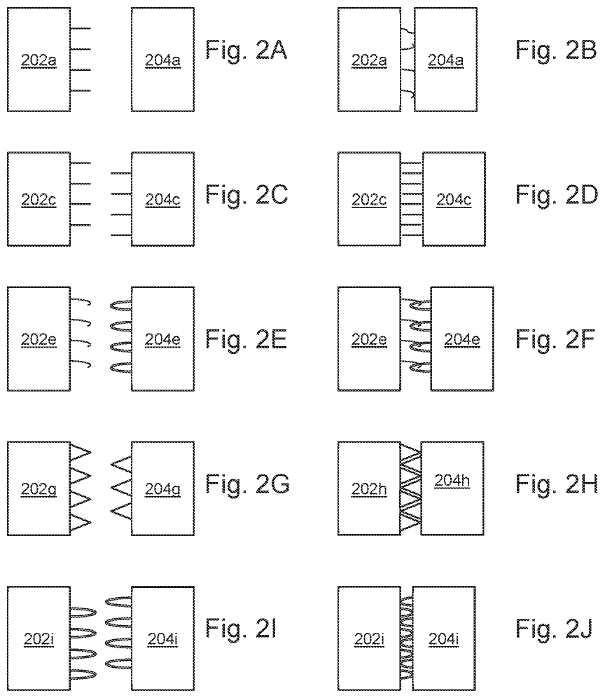

The protruding features 106 of the first molding apparatus section 100 may take various forms. Some examples are now described in further detail in FIGS. 2A to 2J.

FIGS. 2A to 2J show cross sections of joining portions of a first molding apparatus section 202a-i and a second molding apparatus section 204a-i. Each of the first molding apparatus sections 202a-i comprise protruding features. In the example shown in FIGS. 2A and 2B the second molding apparatus section 204a does not comprise protruding features however in each of the examples shown in FIGS. 2C to 2J both the first and second molding apparatus sections 202c-i, 204c-i comprise protruding features.

FIGS. 2A and 2B show a first molding apparatus section 202a similar to the first molding apparatus section 100 described in relation to FIG. 1. The protruding features of the first molding apparatus section 202a are thin features which extend substantially perpendicular to a surface of the first molding apparatus section 202a. The features may be arranged in a regular or irregular array (which may be a two dimensional array). The features may have a substantially circular cross section in a plane perpendicular to the axis of each feature, however in other examples the cross section may have another shape. In some examples the cross section may vary along the length of each feature, for example the features may be tapered i.e. thicker near their base and become thinner as the distance increases from the surface of the first molding apparatus section 202a. The protruding features may take the form of rods or bristles.

In this example the second molding apparatus section 204a comprises a face which is substantially parallel to the surface of the first molding apparatus section 202a which is provided with the protruding features. In this example this face of the second molding apparatus section 204a a substantially flat face facing towards the features of the first molding apparatus section 202a, however in some examples both faces may have a more complex geometry, for example they may be curved or have multiple sections of flat faces.

FIG. 2A shows the first molding apparatus section 202a and the second molding apparatus section 204a prior to assembly, such that the first molding apparatus section 202a and the second molding apparatus section 204a do not contact each other. FIG. 2B shows the first molding apparatus section 202a and the second molding apparatus section 204a when they have been assembled together to form a pulp molding component and the protruding features of the first molding apparatus section 202a contact a face of the second molding apparatus section 204a. In this example the protruding features are flexible. As can be seen in FIG. 2B when the first and second molding apparatus sections 202a, 204a are assembled together, the protruding features of the first molding apparatus section 202a butt against the face of the second molding apparatus section 204a and flex or bend.

In examples wherein the protruding features are flexible, the molding apparatus section/pulp molding component may be more robust to variations in dimensions. For example, if the gap between molding apparatus sections is larger or smaller than intended, the protruding features may flex to account for this difference in size. In this way, by providing flexible protruding features, the distance between the faces of the first and second molding apparatus sections may have a wider manufacturing tolerance, thereby simplifying manufacture and assembly. Furthermore, in this example the second molding apparatus section 204a is not provided with any features which correspond to the protruding features of the first molding apparatus section. Therefore, when assembling the first and second molding apparatus sections 202a, 204a, their relative positions in the directions parallel to their mating faces may also be varied which may further simplify manufacture and assembly of the sections 202a, 204a. In other examples however the protruding features may be substantially rigid.

The protruding features of this example, and of any of the examples described below, may for example have a length dimension of less than 1 mm, for example in the range 0.2 mm to 1 mm, for example around 0.5 mm. For example, the dimension may be the length which the protruding features protrude from a surface of the joining portion. In some examples the dimension may be the cross sectional diameter of the protruding features. In some examples, where the protruding features are generated using additive manufacturing, their smallest dimension may be greater than or equal to the minimum feature size which can be generated by the additive manufacturing process used.

FIG. 2C and FIG. 2D show a second example of first and second molding apparatus sections 202c, 204c wherein both of the first and second molding apparatus sections 202c, 204c comprise protruding features. FIG. 2C shows the first and second molding apparatus sections 202c, 204c prior to assembly and FIG. 2D shows the first and second molding apparatus sections 202c, 204c after assembly to form a pulp molding component. When the first and second molding apparatus sections 202c, 204c have been assembled to form a pulp molding component the protruding features of each of the first and second molding apparatus sections 202c, 204c mesh together i.e. the protruding features of the first molding apparatus sections 202c fit within spaces between the protruding features of the second molding apparatus section 204c and the protruding features of the second molding apparatus sections 204c fit within spaces between the protruding features of the first molding apparatus section 202c. This may be achieved by the protruding features being arranged as relatively offset arrays protruding from the faces of the sections 202c, 204c when the sections are assembled to form a pulp molding component. Providing meshing features may increase the surface area encountered as the pulp moves through the gap, and thus improve the efficiency with which the seal is formed. It may also disrupt the flow to increase the likelihood that a fibre of the pulp is caught on a protruding feature.

Although the protruding features are shown as protruding perpendicular to surfaces of the first and second molding apparatus sections 202c, 204c, in some examples the protruding features may be at other angles relative to the surfaces. When the protruding features are non-perpendicular the angle may help create a ‘soft-mating’ between the first and second molding apparatus sections 202c, 204c. In some examples the protruding features are substantially parallel however in other examples they may protrude at a variety of angles. The protruding features of the first and/or second molding apparatus sections 202c, 204c may be rigid or flexible. When the features are relatively stiff, they may assist in locating the first and second molding apparatus sections 202c, 204c, however relatively flexible features may be more robust to variations in dimensions as described above.

FIG. 2E and FIG. 2F show a third example a first and second molding apparatus sections 202e, 204e wherein both of the first and second molding apparatus sections 202e, 204e comprise protruding features. FIG. 2E shows the first and second molding apparatus sections 202e, 204e prior to assembly and FIG. 2F shows the first and second molding apparatus sections 202e, 204e after assembly. In this example the protruding features of the first molding apparatus section 202e comprise hook shaped portions and protruding features of the second molding apparatus section 204e comprise loops. In other examples each of the first and second molding apparatus sections 202e, 204e may comprise a mixture of features with hooks and features with loops. When the first and second molding apparatus sections 202e, 204e are assembled, as shown in FIG. 2F, the hooks of the protruding features of the first molding apparatus section 202e interact with the loops of the second molding apparatus section 204e, for example the hooks may engage with the opening of the loops such that the protruding features of the first and second molding apparatus sections 202e, 204e are interlinking. The interlinking loops and hooks may provide a more secure join between the first and second molding apparatus sections 202e, 204e while still forming openings to allow a fluid to flow through and impeding the motion of fibers such that they accumulate to form a seal between the first and second molding apparatus sections 202e, 204e. For example, the engagement of the hooks with loops may provide resistance against out-of-plane displacements.

FIG. 2G and FIG. 2H show a fourth example a first and second molding apparatus sections 202g, 204g wherein both of the first and second molding apparatus sections 202g, 204g comprise protruding features. FIG. 2G shows the first and second molding apparatus sections 202g, 204g prior to assembly to form a pulp molding component and FIG. 2H shows the first and second molding apparatus sections 202g, 204g after assembly. The protruding features of the first and second molding apparatus sections 202g, 204g are tapered such that, when assembled, the protruding features of the first and second molding apparatus sections 202g, 204g mesh. In this example the protruding features are tapered such that their axial cross section is triangular, however in other examples meshing features may be provided with different cross sections. When such features are rigid, they may reduce the degrees of freedom of movement of the first and second molding apparatus sections 202g, 204g along certain axes. In this example the features may substantially prevent relative vertical motion of the first and second molding apparatus sections 202g, 204g. The tapered nature of the features may assist in accurately locating the sections 202g, 204g relative to each other when forming the pulp molding component. The intermeshing of the features may be a two-dimensional intermeshing. For example, the features may be offset from one another in two dimensions when assembled to form the pulp molding component.

FIG. 2I and FIG. 2J show a fifth example a first and second molding apparatus sections 202i, 204i wherein both of the first and second molding apparatus sections 202i, 204i comprise protruding features. FIG. 2I shows the first and second molding apparatus sections 202i, 204i prior to assembly and FIG. 2J shows the first and second molding apparatus sections 202i, 204i after assembly. In this example the protruding features of both the first and second molding apparatus sections 202i, 204i comprise flexible loops. As can be seen in FIG. 2J when the first and second molding apparatus sections 202i, 204i are assembled the protruding features of each are deformed or compressed. This may allow variations in dimensional tolerances while providing small openings between the first and second molding apparatus sections 202i, 204i to allow fluid to pass through while impeding motion of fibers so that they form a seal between the first and second molding apparatus sections 202i, 204i.

In some examples, first and/or second molding apparatus sections 202a-i, 204a-i may comprise more than one type of protruding features. For example, a first portion of a molding apparatus section may comprise one type of protruding feature and another portion may comprise another type of feature.

In some examples, the different types of features described in FIGS. 2A to 2J may be combined in a ‘fractal-like’ manner with smaller protruding features provided on larger protruding features. For example, the bristle-like features of FIGS. 2A to 2D may be provided with even smaller bristles located on the features. In some examples, different types of features may be combined in this way, for example the bristle-like features of FIGS. 2A to 2D may be provided on the tapered protruding features of FIGS. 2G and 2H.

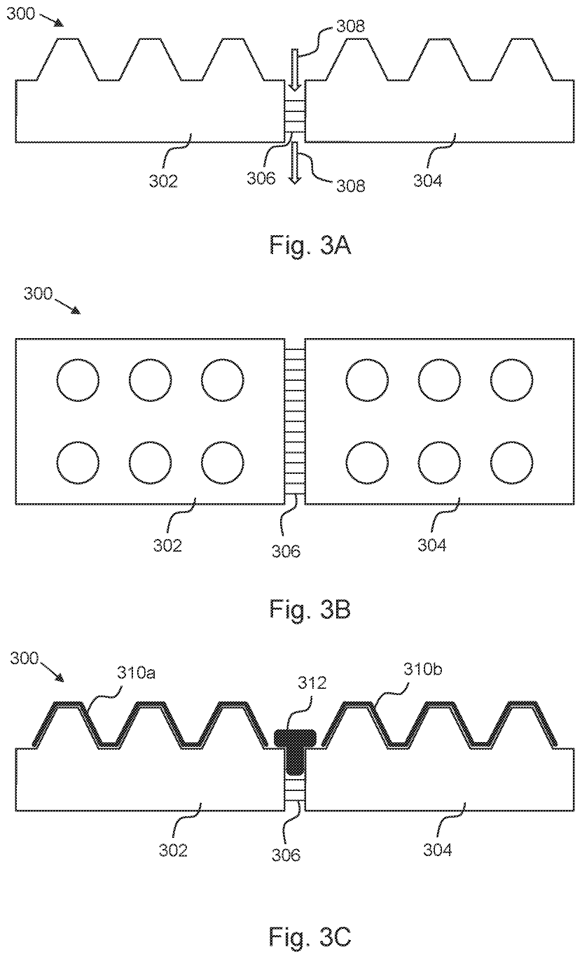

FIGS. 3A, 3B, 3C and 3D show plan views of a pulp molding apparatus components 300, 300′.

FIG. 3A shows a side view of the pulp molding apparatus component 300 and FIG. 3B shows a top-down view of the pulp molding apparatus component 300. In this example the pulp molding apparatus component 300 comprises a first molding apparatus part 302 and a second molding apparatus part 304 adjacent to the first molding apparatus part. In this example, the pulp molding apparatus component 300 is a pulp molding form, but in other examples the pulp molding apparatus component 300 may comprise a die, screen or transfer member. Each part 304 may comprise a section as described in relation to FIG. 1 and/or FIGS. 2A-2J.

In this example the pulp molding apparatus component 300 comprises two molding apparatus parts, however in other examples pulp molding apparatus components may comprise any number of molding apparatus parts. The first and/or the second molding apparatus parts 302, 304 may formed using additive manufacturing, for example 3D printing as described in relation to FIG. 1.

The first molding apparatus part 302 comprises features 306 extending towards the second molding apparatus part 304 to impede a motion of pulp fibers therebetween to form a seal between the first and second molding apparatus parts 302, 304. In this example, the features 306 are similar to the protruding features 106 described in relation to FIG. 1, however the features 306 may take any suitable form, for example as described in relation to FIGS. 2A to 2J. For example, the second molding apparatus part 304 may further comprise features extending towards the first molding apparatus part 302 as described in relation to FIGS. 2C to 2J. In some examples the features 306 of the first molding apparatus part 302 are interlocking, meshing or cooperating with the features of the second molding apparatus part 304 as described in relation to FIGS. 2C to 2J. The features 306 of the first and/or second molding apparatus parts 302, 304 may be rigid or flexible.

Following assembly of the pulp molding apparatus component 300, an opening may exist between the first molding apparatus part 302 and the second molding apparatus part 304, through which liquid can flow, as indicated by arrows 308.

The first and second molding apparatus parts 302, 304 may be assembled to form the pulp molding apparatus component 300 such that they may be subsequently disassembled. In other words, they may be reversibly assembled to permit disassembly and reassembly. For example, they may comprise corresponding holes through which pins, rods or bolts may be inserted or they may comprise corresponding alignment features such as corresponding ridges or channels may be provided. When a seal is formed between the first and second molding apparatus parts 302, 304 it may be removed to permit disassembly, for example using pressurized water. In some other examples the first and second molding apparatus parts 302, 304 may be permanently assembled and in such examples, adhesives may be used to join the first and second molding apparatus parts 302, 304. The increased surface area provided by the protruding features 306 may provide an improved interface for such adhesives to bond to, thereby creating a stronger bond.

FIG. 3C shows a side view of the pulp molding apparatus component 300 after a pulp molding operation. In this example two pulp molded objects 310a, 310b have been formed on the pulp molding apparatus component 300. To form the objects 310a, 310b the pulp molding apparatus component 300 may have been submersed in a slurry comprising a liquid and solid fibrous material. The liquid, at least in part, may have been drawn through first and second molding apparatus parts 302, 304 of the pulp molding apparatus component 300 causing the solid fibrous material to accumulate on the first and second molding apparatus parts 302, 304 thereby forming the objects 310a, 310b. As the liquid is drawn through the first and second molding apparatus parts 302, 304 some liquid also passes through the gap between the first and second molding apparatus parts 302, 304 (indicated by arrows 308 in FIG. 3A). The protruding features 306 cause fibers to accumulate forming a seal 312. In this example the fibers accumulate both in the gap between the first and second molding apparatus parts 302, 304 and on a top surface of the first and second molding apparatus parts 302, 304 to form a seal 312 with a “T-shaped” cross section, however in practice the seal 312 may have another shape of cross section.

FIG. 3D shows another example of a side view of a pulp molding apparatus component 300′ after a pulp molding operation. In this example a pulp molded object 310′ is formed across first and second molding apparatus parts 302′, 304′. The formed pulp molded object 310′ spans the gap between the first and second molding apparatus parts 302′, 304′. The first pulp molding apparatus part 302′ comprises protruding features 306′ extending towards the second pulp molding apparatus part 304′. In this example, during a pulp molding operation, the fibers accumulate on the protruding features 306′ to form a seal 312′. The pulp molded object 310′ is formed above the seal 312′. This allows larger pulp molded objects to be formed than would be possible using one of the first and second molding apparatus parts 302′, 304′.

When the seal is formed it may reduce the rate of flow of material (liquid and/or solid material) through the gap between the first and second molding apparatus parts 302, 304 thereby reducing leaks between assembled parts of the pulp molding apparatus component 300. In some examples the seal 312 may completely prevent the flow of fluids through the gap. Reduced leaks may result in improved quality of formed objects 310, fewer scrap objects and improved transfer of objects 310, thereby providing improved process efficiency.

The sections and components of FIG. 1, FIGS. 2A to 2J and FIG. 3A to D (and also the other Figures herein) are not to scale and in particular, the gap between sections or parts may be exaggerated in order to illustrate the concepts described herein.

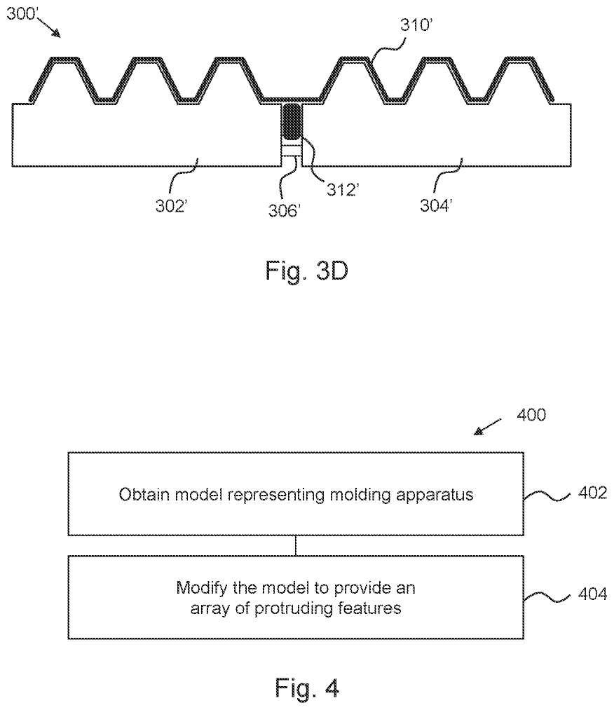

FIG. 4 is an example of a method 400, which may comprise a method for obtaining and modifying a model representing a portion of a molding apparatus, for example to obtain a model representing a portion of a molding apparatus comprising features to cause a molded pulp seal to form. The method may be carried out at least in part by processing circuitry, which may comprise at least one processor. In some examples the processing circuitry may be part of, or associated with, an additive manufacturing apparatus. The portion of the molding apparatus may be a molding apparatus section as described in relation to FIG. 1 and FIGS. 2A to 2J or molding apparatus part as described in relation to FIGS. 3A to 3D.

The method 400 comprises, in block 402, obtaining a model representing a portion of a molding apparatus. Additive manufacturing systems may generate objects based on structural design data, for example a model representing an object to be generated. This may involve a designer determining a three-dimensional model of an object to be generated, for example using a computer aided design (CAD) application. The model may define the solid portions of the object. To generate a three-dimensional object from the model using an additive manufacturing system, the model data can be processed to define slices or parallel planes of the model. Each slice may define a portion of a respective layer of build material that is to be solidified or caused to coalesce by the additive manufacturing system.

In some examples the model represents surface(s) of an object. In some examples, the data of the first data model may provide the representation of the object as at least one design file, such as a STL file, a .OBJ file, a DXF file, a 3mf file, STEP file, IGES file or the like.

In this example the obtained model represents a portion of a molding apparatus, for example it may represent first molding apparatus section 100 as described in relation to FIG. 1, a first or second molding apparatus section 202a-i, 204a-i as described in relation to FIGS. 2A to 2J or a first or second molding apparatus part 302, 304 as described in relation to FIGS. 3A to 3D. In some examples a model representing a pulp molding apparatus component (e.g. a die, a screen, a form or a transfer member) or an entire pulp molding toolset may be obtained and the model representing a portion of a molding apparatus may be obtained therefrom.

The method 400 comprises, in block 404, modifying the model to provide an array of protruding features at a periphery of the portion of the molding apparatus to trap pulp fibers. The protruding features may be the protruding features 106 described in relation to FIG. 1, any of the protruding features described in relation to FIGS. 2A to 2J or the features 306 described in relation to FIGS. 3A to 3D.

The model may define a joining portion (as described in relation to FIG. 1) to which the features are added. In some examples the location of the protruding features maybe specified by a user. In some examples the location of the protruding features may be determined automatically, for example by identifying portions of the portion of the molding apparatus which are to be joined with another portion of the molding apparatus. The identified portions may then be modified to add the protruding features.

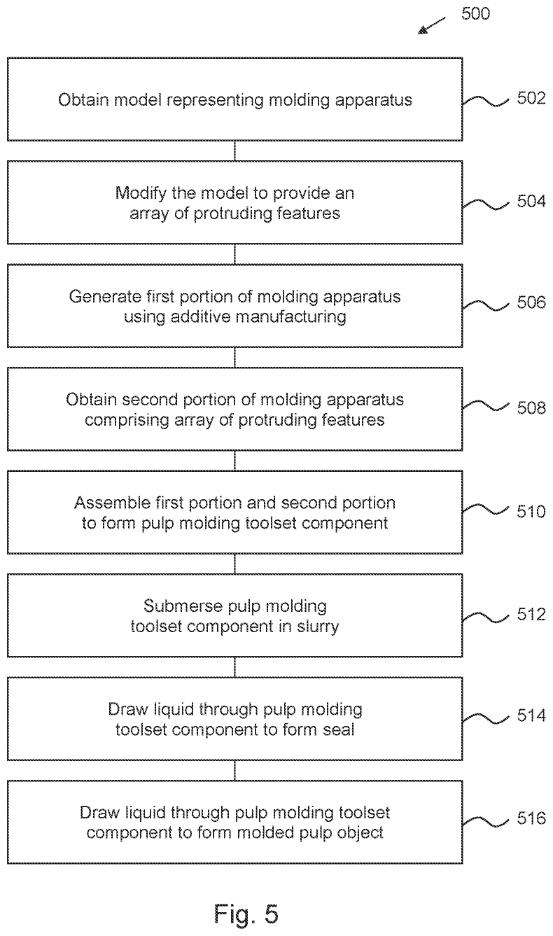

FIG. 5 shows an example of a method 500, which may comprise a method for forming a pulp molding toolset component and forming a molded pulp object using the pulp molding toolset component. FIG. 5 provides an example of the method 400 of FIG. 4.

The method 500 comprises, in block 502, obtaining a model representing a first portion of a molding apparatus and, in block 504, modifying the model to provide an array of protruding features at a periphery of the first portion of the molding apparatus to trap pulp fibers as described in relation to FIG. 4.

The method 500 comprises, in block 506, generating the first portion of the molding apparatus comprising the protruding features using additive manufacturing. Generating the first portion of the molding apparatus may comprise generating control instructions for controlling an additive manufacturing apparatus to generate the object according to the modified model. The control instructions may comprise instructions which, when executed by an additive manufacturing apparatus cause the additive manufacturing apparatus to generate the first portion of the molding apparatus comprising the protruding features. For example, the instructions may define quantities and locations to deposit agents, such as fusing agents, and may associate a print instruction with each voxel.

In order to generate the first portion of the molding apparatus comprising the protruding features, print agent may be selectively deposited onto portions of build material. For example, a fusing agent may be deposited in areas which are intended to be solidified to generate the first portion of the molding apparatus comprising the protruding features.

Generating the first portion of the molding apparatus comprising the protruding features using additive manufacturing may comprise obtaining data describing which portions of build material print agent is to be deposited upon. For example, fusing agent may be deposited onto build material corresponding to a location of a voxel which is categorised as being ‘black’, and thus additive manufacturing instructions may be based on the modified model representing the first portion of the molding apparatus comprising the protruding features to be generated.

In other examples, other additive manufacturing techniques may be used to generate the first portion of the molding apparatus comprising the protruding features.

The method 500 comprises, in block 508, obtaining a second portion of the molding apparatus comprising an array of protruding features. In some examples the second portion may be generated using additive manufacturing in a similar manner to the first portion. In other examples the second portion may be formed using another method, for example machining techniques, such as CNC milling.

In some examples the second portion may be a second molding apparatus section 204a-i as described in relation to FIGS. 2A to 2J. The second molding portion may comprise protruding features to interact with the protruding features of the portion when the first and second portions are assembled, for example as described in relation to FIGS. 2C to 2J. For example, the second portion may comprise protruding features to cooperate, mesh, interlock or otherwise interact with the first portion.

The method 500 comprises, in block 510, assembling the first portion and the second portion to form a pulp molding toolset component by arranging the first portion adjacent to the second portion such that the array of protruding features of the first portion interacts with the array of protruding features of the second portion.

The pulp molding toolset component may be the pulp molding apparatus component, or a portion thereof, described in relation to FIG. 1, FIGS. 2A to 2J and FIGS. 3A to 3D. A pulp molding toolset component may comprise a transfer member and a die, wherein the die may comprise a screen and a form. Each component of the pulp molding toolset may be assembled from one portion or multiple portions, each of which may be provided with protruding features to interact with an adjacent portion. In some examples a subset of the portions are provided with protruding features. For example, portions of the die on which the fibers accumulate to form a pulp molded object may be provided with the protruding features to cause pulp fiber seals to form between them, whereas portions of the transfer member may not be provided with protruding features because the transfer member may not be submersed in the slurry. Furthermore, the die may be submersed in the pulp resulting in a fiber pulp seal forming on the protruding features. The die may have a larger influence on the quality of the object which is formed thereon than the transfer member, therefore the protruding features may be provided on portions of the die even if they are not provided on portions of the transfer member.

The method 500 comprises, in block 512, submersing the pulp molding toolset component in a slurry comprising fibers and a liquid. The slurry may be formed by mixing liquid and fibrous material. In some examples the fibrous material comprises paper or card, and may comprise recycled material.

The method 500 comprises, in block 514, drawing the liquid through the pulp molding toolset component to accumulate fibers on the protruding features of the first portion and the second portion to form a seal between the first portion and the second portion. As the liquid is drawn through the pulp molding toolset component, if there are any gaps between the pulp molding toolset component and an adjacent component liquid may leak through these gaps while pulp fibers in the slurry may interact with the protruding features and accumulate between the first and second portions. When enough fibers have been accumulated, the gap between the first and second portions may become substantially blocked by the fibers thereby reducing the amount of fluid which can leak between the first and second portions. The accumulated fibers may be referred to as a seal because they may act to seal the gap between the first and second portions. Thus, due to the presence of the protruding features, the gap may be self-sealing.

Drawing liquid through the pulp molding toolset component to accumulate fibers on the protruding features to form the seal may be performed prior to using the pulp molding toolset component to form a pulp molded object. For example, it may take some time for enough fibers to accumulate to form a seal. Therefore, one priming run or multiple priming runs may be performed prior to using the molded fiber toolset component in production operations. Objects may be incidentally formed during such priming operations however they may not be used (e.g. scrapped or recycled). In some examples the priming runs may also function as test runs, for example to check alignment of the pulp molding toolset component and to verify process parameters (e.g. temperature, flow rates, pressure, consistency of the pulp, etc.).

The method comprises, in block 516, drawing the liquid through the pulp molding toolset component to accumulate fibers on the pulp molding toolset component to form a molded pulp object. When a pulp molding toolset component, such as a die, is submersed in the slurry, the liquid component of the slurry may pass through the die while the solid, fibrous material in the slurry accumulates on the surface of the screen of the die. This may be achieved by moving the die through the slurry and/or by reducing pressure behind the die to suck the liquid through the screen. The thickness of the object formed by the accumulated material may depend on the type of fibrous material, temperature, the duration the die is submersed in the slurry, the ratio of liquid to solid material in the slurry, other additives in the slurry and/or pressure applied. In some examples, the die may be removed from the slurry, and the process of drawing liquid through the screen of the pulp molding die may take place or continue after the die has been removed from the slurry.

When the pulp molded object is formed after the seal is formed, leaks between portions of the pulp molding apparatus are reduced and therefore the quality of the formed object is improved relative to objects formed without such a seal.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A first molding apparatus section comprising:
a body portion for forming at least part of a pulp molded object; and
a joining portion to mate with at least a second molding apparatus section to form a pulp molding apparatus component, the joining portion comprising a plurality of protruding features which interact with pulp molding fibers to form a seal between the first and second molding apparatus sections.

2. An apparatus as claimed in claim 1, wherein the body portion and the joining portion, comprising the protruding features, are integrally formed using additive manufacturing.

3. An apparatus as claimed in claim 1, wherein the protruding features are flexible.

4. An apparatus as claimed in claim 1, wherein when the joining portion of the first molding apparatus section is mated with a second molding apparatus section the protruding features provide openings for a fluid to flow through.

5. An apparatus as claimed in claim 1 wherein the pulp molding apparatus component is a screen, a form or a transfer member.

6. An apparatus as claimed in claim 1, wherein the protruding features protrude from a surface of the joining portion to a length of 0.2 mm to 1 mm.

7. A pulp molding apparatus component comprising:
a first molding apparatus part; and
a second molding apparatus part adjacent to the first molding apparatus part,
wherein the first molding apparatus part comprises features extending towards the second molding apparatus part to impede a motion of pulp fibers therebetween to form a pulp fiber seal between the first and second molding apparatus parts.

8. A pulp molding apparatus component as claimed in claim 7, wherein the second molding apparatus part further comprises features extending towards the first molding apparatus part.

9. A pulp molding apparatus component as claimed in claim 8, wherein the features of the first molding apparatus part are interlocking, meshing or cooperating with the features of the second molding apparatus part.

10. A pulp molding apparatus component as claimed in claim 7, comprising an opening between the first molding apparatus part and the second molding apparatus part for liquid to flow through.

11. A method comprising:
obtaining a model representing a portion of a molding apparatus; and
modifying the model to provide an array of protruding features at a periphery of the portion of the molding apparatus to trap pulp fibers.

12. The method of claim 11, further comprising:
generating the portion of the molding apparatus comprising the protruding features using additive manufacturing.

13. The method of claim 12 wherein the portion of the molding apparatus is a first portion, and the method further comprises:
obtaining a second portion of the molding apparatus comprising an array of protruding features; and
assembling the first portion and the second portion to form a pulp molding toolset component by arranging the first portion adjacent to the second portion such that the array of protruding features of the first portion interacts with the array of protruding features of the second portion.

14. The method of claim 13 further comprising:
submersing the pulp molding toolset component in a slurry comprising fibers and a liquid; and
drawing the liquid through the pulp molding toolset component to accumulate fibers on the protruding features of the first portion and the second portion to form a seal between the first portion and the second portion.

15. The method of claim 14 further comprising:
drawing the liquid through the pulp molding toolset component to accumulate fibers on the pulp molding toolset component to form a molded pulp object.
